(19) United States
(12) Patent Application Publication
(10) Pub. No.: US 2018/0266524 A1
(43) Pub. Date: Sep. 20, 2018

(54) guzman transmission

(71) Applicant: Camilo Ernesto Guzman, Laval (CA)

(72) Inventor: Camilo Ernesto Guzman, Laval (CA)

(21) Appl. No.: 15/460,819

(22) Filed: Mar. 16, 2017

(51) Int. Cl. F16H 3/66; F16H 61/00; F16H 61/06

(52) U.S. Cl. CPC F16H 3/666; F16H 61/0009; F16H 2037/049; F16H 2061/0012; F16H 61/068

(57) ABSTRACT

The invention relates to, in essence, a positive engaged infinitely variable transmission combining a 90° planetary axial gear (differential) with a double radial planetary gear so, the sun gear of the first planetary gear system is solidary to the second planetary gear assemblie sun gear, and that the ring gear of the first planetary gear system is solidary with the planet carrier of the second planetary gear system offering a inertial configuration, or. By combining an axial gear system at 180°, equivalent to a double radial planetary gearbox (the second planet gear is used to change the motion vector between 90° and 180°) to a second axial gear system, uniting the first sun gear with the second sun gear and, the first ring gear with the second planet carrier.

The first planet carrier, which is now the anchor point of the system, is geared to a hydraulic loop with a flow valve that controls it at will.

### TECHNICAL FIELD

The present invention relates generally to a mechanical transmission which is capable of being shifted between an infinite number of forward and reverse speeds between the start and final speed/torque ratio, including neutral and reciprocal blocking in a configuration including a fixed number of gears acting as a real time IVT (Infinitely Variable Transmission) and, or as a torque/speed divider.

### BACKGROUND OF THE INVENTION

Infinitely Variable Transmission provides variable and unlimited speed ratios between the power demand and the source of movement. It will improves the engine efficiency while reducing the fuel consumption offering new possibilities to angular motion exploitation.

Up until today, all conceived transmissions only exploit one vector at a time, by either transforming force into speed or speed into force. When the work parameters of the task to be accomplished demands a change from the original configuration, there are two ways to accomplish this change. Either stop the mechanism, or isolate it from the power source so it can be reconfigured. To accomplish an apparently continuous work, a transmission will use, clutches and synchronized coupling/gear devices for each change in speed/force ratio.

When the values of these vectors change during the movement, it becomes increasingly difficult to maintain the continuity of the flux of these values between vectors.

The actual attempts to develop a real time IVT are based on frictional approaches being the mos commonly used the V-Belt CVTs (Continuously Variable Transmissions). The power transmission is achieve through frictional forces, requiring large effective radius, high pulleys clamping pressure and special transmission fluids. It will reduces the use of V-belt CVT in light weight vehicles. High torque demands are not possible to use.

To solve this, the present invention provides a continuously variable forward and reverse speeds while requiring a fixed number of planetary gears and a hydraulic flow control, without brakes nor clutch neither. It varies the angular displacement o rotational movement separating the contained vectors (speed and torque) to exploit in a reciprocal manner the working flow by maintaining the full potential of the movement force source without a continuity flow break-up.

### OBJECTS OF THE INVENTION

The objects of the invention are to provide a positive engaged infinitely variable planetary transmission capable to shift from infinity to zero speed ratio in the same or opposite direction offering reciprocal blocking and supporting high torque and power and.

Offers new possibilities of exploitation to pendulum, linear, an angular motion.

### SUMMARY OF THE INVENTION

The angular movement or rotation contains two exploitable vectors to generate the energy and the mechanical work: The speed and the displacement force/torque. This invention separates the input vectors and displaces the contained values in its tangent (the present movement's constant) to change the output values in a constant and instantaneous reciprocal manner.

From this torque/speed distribution principle (FIG. 1) emerges three basic configurations. The first one (FIG. 2) uses two planetary gear sets with different vectorial angles. This inertial configuration responds to the opposite resistance to the output movement by a translation of the vectors in a reciprocal manner. In this way, an angular input movement will output an opposite torque proportional to the resistance, developing speed as the resistance diminishes.

A main (primary) planetary gear set acting as driving shaft is meshed with a second planetary gear set acting as an output shaft. The main (primary) gear set splits the angular motion of its satellite carrier between the sun gear and the ring gear, the sun gear is meshed with the second planetary gear set sun gear, and the ring gear is meshed with the satellite carrier of the second planetary gear set, once the motion initiate, the ring gear will opposite more resistance than the sun gear, then it starts the motion while the ring gear and the second satellite carrier don't move. So the second planetary gear set ring gear will follow the same rotation direction providing the initial speed or “first”. Once the motion is initiated, and resistance decrease, the secondary gear set satellite carrier starts rotating to increase the second ring gear speed until it reaches the same primary sun gear speed or in this case the maximum source speed.

This is quite useful to replace much more complex systems like automatic transmissions found on such vehicles like scooters, automatic/differential drive train systems in automobiles and multipurpose vehicles, inertial accumulators etc.

The second configuration (FIG. 4) uses two planetary gear sets with identical vectorial angles. This dynamic configuration responds to the user's commands using a hydraulic loop as flow control to do it.

This control is a geared hydraulic pump with external teeth drive meshed with the first planetary gear set satellite carrier, the system recirculate a hydraulic loop interfered by a ball type valve, when this valve is open, the satellite carrier turns freely, while the valve closes, the loop increases resistance and the satellite carrier slowdowns the speed, initiating the motion of the second planetary gear set satellite carrier, and in consequence accelerating the output speed. The process is completely reversible and could be increased until reach the zero point, offering all the range of the speed/torque ratio contained in the motion.

In the second configuration we have also a planetary gear set acting as driving shaft meshed with a second planetary gear set acting as an output shaft. The main (primary) gear set splits the angular motion of its sun gear between the planet carrier and the ring gear, the sun gear is meshed with the second planetary gear set sun gear, and the ring gear is meshed with the satellite carrier of the second planetary gear set, once the motion initiate, the sun gear transmits the motion to the satellite gear meshed among the satellite carrier with a hydraulic loop, this is a simply geared hydraulic pump driving the compressed oil in a closed loop interfered by a valve. This loop meshed with the first satellite carrier has as purpose to splits the vectors leaving the satellite carrier free at the beginning of the motion, so the second satellite carrier don't move and the second ring gear will follow the same rotation direction providing the initial speed or “first”. Once the motion is initiated we can increase the loop resistance by closing the valve to slowdown the speed of the first satellite carrier, and starts the second satellite carrier motion, the second ring gear increases speed, until it reaches the same primary sun gear speed when the first satellite carrier is completely stopped by the hydraulic flow control, achieving in this case the maximum source speed.

For an automatic system it uses an auto-piloted hydraulic valve that allows a torque sensible response configuring a quasi-ideal automatic transmission.

This configuration replaces manual transmissions, automatic dynamic controlled and automatic/manual gearboxes in cars and trucks.

By combining these configurations, this invention will allows the development of new possibilities for mechanical angular movement. Highly efficient inertial vehicles could be designed because the storage of kinetic energy would be then, used with the displacement of its vectors during the peak of its trajectory.

Its also configures a dynamic flux controller by itself, that can be feedback inside a mechanical system to obtain an automatic output controller without electronic controls.

It offers also a solution to the loss of drive suffer by the actual differential systems. If we uses one of the reciprocal control configuration system in each drive tire (two or four), calibrate to reach the maximum differential speed needed when the vehicle turns the system never will reach a total drive loss.

The third configuration allows to inverse the entire angular motion to the opposite angular movement. It uses two planetary gear sets with different vectorial angles meshed with two reciprocal hydraulics loops. Each loop is an actuator to switch the motion between the planetary gear sets. This configuration combined with one of the describes below allows to use the full possibilities existing in an angular motion including a ratio reduction, over-multiplication, the full range of forwards speeds, reverse, neutral and reciprocal blocking (parking).

Consequently, this invention offers absolute control of the work source values and allows an optimal exploitation of the sources work potential.

### BRIEF DESCRIPTION OF THE DRAWINGS

FIG. 1 is a diagrammatic front view of the planetary gear set innertial configuration.

FIG. 2 is a diagrammatic and sectional view of the inertial transmission configuration.

FIG. 3 is a diagrammatic front view of the dynamic control configuration.

FIG. 4 is a diagrammatic and sectional view of the dynamic control transmission configuration.

### DESCRIPTION OF THE EMBODIMENT

Referring to FIG. 1, a planetary axial 180° gearset (1), which allows the ring gear (3) to turn in the same direction that's the sun gear (1) does.

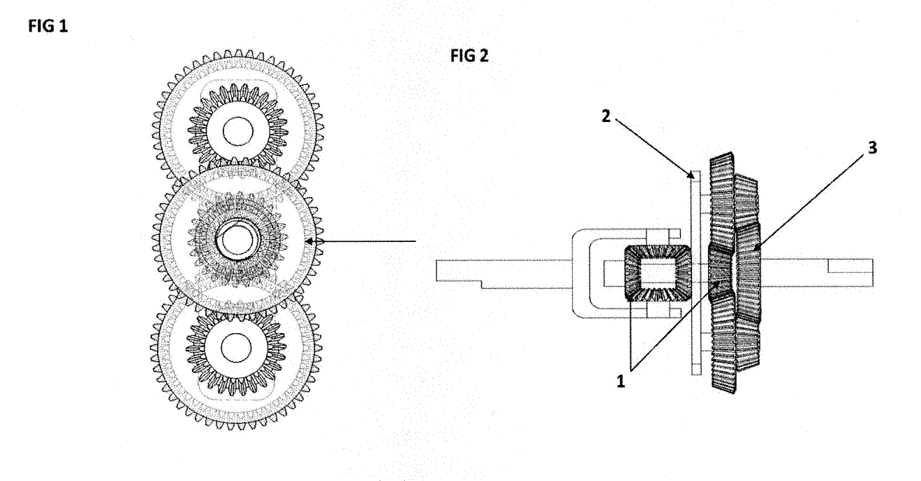

Referring to FIG. 2 the planetary axial 180° gearset is driven by a planetary axial 90° gear set shaft to the sun gear (1) and the planetary carrier (2), the drive shaft is connected to an internal combustion engine of any other power source (hydroelectric turbine) and the two half shafts are connected with the sun gear (1) and the planet carrier (2) splitting the input angular torque between both. As the angular speed of the ring gear (3) increases the resistance over the planet carrier (2) will decrease and the half shaft connected to it will start turning until it reaches the same speed, by so reaching the final speed.

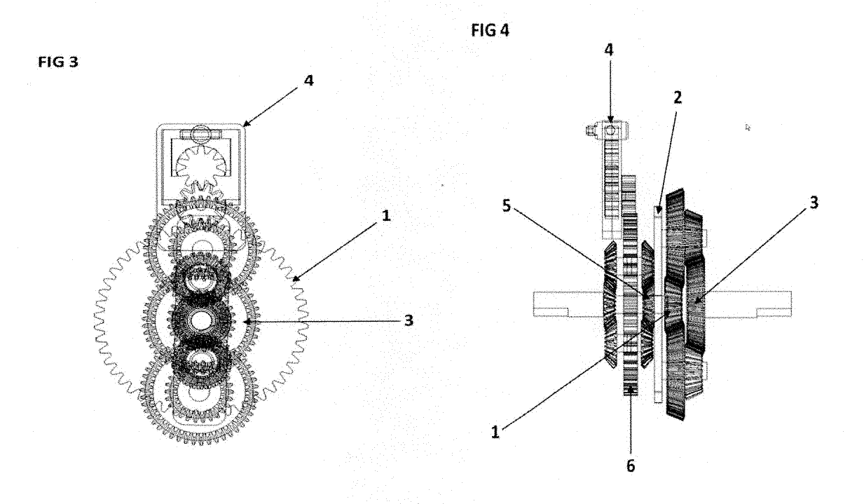

Referring to FIG. 3 a planetary axial 180° gearset (1), which allows the ring gear (3) to turn in the same, direction that's the sun gear (1) does and the hydraulic flow control (4) that controls the planetary carrier anchor point.

Referring to FIG. 4 the planetary axial 180° gearset is driven by a second identical configured planetary gear set in which the ring gear (5) acts as planetary carrier for the secondary planetary gear set, the angular velocity is controlled by a hydraulic flow control geared with the planetary carrier (6). As the motion starts the ring gear (5) is immobile while the planet carrier (6) turns backwards given us the initial speed or “first”, then the hydraulic flow control decreases the rotation speed of the planet carrier (6) (anchor point) increasing the angular speed of the ring gear (2) until the planet carrier (6) stops the rotation reaching the final speed.

1. A positive engaged infinitely variable transmission comprising: two set of planetary gear meshed in an axial or radial configuration that allows to splits the angular working motion vectors.

2. The transmission of claim 1 including an axial or radial 90° planetary gear set acting as input power splitter between the sun gear and the planet carrier and a second axial or radial 180° planetary gear set acting as output power shaft.

3. The transmission of claim 1 including an axial or radial 180° planetary gear set acting as input power split between the sun gear and the planetary carrier and a second axial or radial 180° planetary gear set acting as output power shaft

4. A hydraulic flow control system acting as a translational satellite carrier anchor point comprising: a hydraulic pump feeding a hydraulic close loop interfered by a manual or auto-piloted valve and drive meshed with an axial or radial planetary system satellite carrier to controls its motion.

5. The transmission of claim 3 including the hydraulic flow control system acting as a translational satellite carrier anchor point.

6. The transmissions of claims 2 and 5 including two planetary gear sets with opposite vectorial angles acting as motion inverter.

7. The transmissions of claim 6 including two reciprocal hydraulic flow control systems acting as actuator to switch the motion between the opposite vectorial angles planetary gear sets

8. The transmissions of claims 2,5 and 7 and their uses as a dynamic flux controller.

9. The transmission of claim 2 acting as a torque vectoring device (differential of speeds ratio system).

10. The transmissions of claims 7 and 9 acting as integrated drive system.

11. The transmission of claim 7 acting as individual motion inverter system.

12. The transmission of claim 11 acting as coupled motion inverter system.

13. The transmissions of claims 7 and 12 and their uses as pendulum into angular motion converter.

14. The transmissions of claims 7 and 12 and their uses as linear to angular motion converter.

15. The transmissions of claims 7 and 12 acting as angular to pendulum motion converter.

16. The transmissions of claims 7 and 12 acting as angular to linear motion converter.

17. The hydraulic flow control system of claim 4 and its uses as clutch (motion isolator) or disengagement system in a transmission or motion converter.

18. The hydraulic flow control system of claim 4 acting as motion shifter between components in planetary or epicyclic gear systems.
